(19) United States
(12) Patent Application Publication
(10) Pub. No.: US 2006/0015884 A1
(43) Pub. Date: Jan. 19, 2006

(54) Load roller device with cleaning structure

(75) Inventors: Tsung Jung Kuo, Hsinchu (TW); Jui Chiang Lin, Hsinchu (TW)

Correspondence Address: BIRCH STEWART KOLASCH & BIRCH, PO BOX 747, FALLS CHURCH, VA, 22040-0747, US

(73) Assignee: Lite-On It Corporation

(21) Appl. No.: 10/967,183

(22) Filed: Oct. 19, 2004

(30) Foreign Application Priority Data
Jul. 14, 2004 (TW) 093120988

(51) Int. Cl. G11B 33/02

(52) U.S. Cl. 720/600

(57) ABSTRACT

A load roller device with a cleaning structure is constituted to install a brush on a roller frame in a slot-in loading drive and brush hairs of the brush are got into touch with a load roller so that the cleanness of the brush can be attained through the brush at the same time when the load roller is rotated. A load roller device with a cleaning structure according to the present invention can particularly be used in a slot-in loading drive. The surface of a load roller can be prevented from contaminating after frequently loading and ejecting discs and a disc can be further protected and prevented from scratching when the loading and ejecting of the disc is processed through the load roller device.

### BACKGROUND OF THE INVENTION

This Non-provisional application claims priority under 35 U.S.C. §119(a) on Patent Application No(s). 093120988 filed in Taiwan, Republic of China on Jul. 14, 2004, the entire contents of which are thereby incorporated by reference.

1. Field of the Invention

The present invention relates to a load roller device with a cleaning structure, and more particularly to a load roller device with a cleaning structure in a slot-in loading drive.

2. Description of Related Art

A variety of drives with different types of mechanisms for loading and ejecting a disc such as lid-lifting, cassette loading, tray loading and slot-in loading drives are developed accompanying the progress of optical disc drives. Among these, a rubber roller is installed at the inlet of the slot-in loading drive for loading and ejecting a disc by the rolling effect of the roller. As shown in FIG. 1, when a disc 9 is placed in a disc drive, it is loaded and ejected through a roller 3 of a load roller device by the friction force between the roller 3 and the disc 9. Please refer to FIG. 2. FIG. 2 is a prospective view showing a structure of a load roller device. The load roller device mainly comprises a roller frame 1, a roller supporting bracket 2, a roller 3, and a roller driving gear 4. The driving gear 4 is installed on the roller 3 for engaging with a driving unit such as a motor (not shown in the figure) in a disc drive so that the loading and the ejecting of a disc can be carried out by driving the gear 4 to rotate the roller 3 and thus to move the disc.

Since the loading and the ejecting of a disc is by the rotation of the roller of a load roller device in a conventional slot-in loading drive, contaminants such as powder and dust unseen by a naked eye are unavoidably attached on the surface of the disc. After operating for a certain period of time, the surface of the roller is contaminated by the contaminant from discs got in touch therewith, and the following discs used are then contaminated by the contaminated roller. This will lead to a vicious circle. The contamination incurred on the surface of the roller cannot be avoided after a long term of operation even if a special process is done on the surface of the roller. Therefore, the roller must be cleaned periodically, otherwise not only the disc but also pickup head are easy to be damaged owing to the accumulation of the contaminants.

Accordingly, a cleaning disc for a compact disc player is disclosed in the U.S. Pat. No. 6,646,971. The '971 patent is characterized by a cleaning disc with a shape similar to a compact disc and having an absorbent, textured material disposed on the surface of the cleaning disc. The cleaning disc can be inserted into a slot-in loading drive by means of such a manner that a compact disc is inserted. Contaminants attached on the load roller of the slot-in loading drive thus can be cleaned by getting the load roller in touch with the cleaning disc.

However, such kind of cleaning disc must be additionally used. A user must insert the cleaning disc into a drive to process a cleaning work for the drive periodically. However, not every user has a habit to perform such kind of cleaning operation, and the inner part of the slot-in drive can thus be contaminated as time passes. Furthermore, the surface of a disc can be consequently contaminated and damaged.

Besides, other applications utilizing a load roller to convey or guide objects into and out of the articles, such as the receipt printing device of a cashier machine, the paper loading mechanism of a printer, and a roller blinds, can be contaminated with the contaminants on a load roller so as to cause the deterioration of the operation.

Therefore, the inventor has done the research on the structure of the load roller device and considers that if the deficiencies mentioned above can be solved with an automatic cleaning structure for the roller of the load roller device, and so that the present invention is proposed.

### SUMMARY OF THE INVENTION

The present invention relates to a load roller device with a cleaning structure comprising a load roller, a roller frame and a brush installed on the roller frame. Hairs of the brush are allowed to get in touch with the load roller to clean the contaminants cumulated on the surface of the load roller. Whereby, when the load roller is driven to rotate upon the loading or the ejecting of a disc, the contaminants or dust attached on the surface of the load roller can be brushed off by the brush at the same time so that the cleanness of the load roller can be attained.

More particularly, the present invention relates to a load roller device with a cleaning structure for a slot-in loading drive.

It is an object of the present invention to provide a load roller device with a cleaning structure that includes a load roller, a roller frame used for supporting said load roller, a brush installed on the roller frame and brush hairs thereof got in touch with the load roller so as to clean contaminants attached on the surface of the load roller.

The brush can be a row brush, a roller brush, or a brush disposed on a sliding rail.

If the brush is a roller brush, a gear can be installed on one end of the roller brush and the gear is driven by a roller brush driving unit. Or a belt wheel can be installed on one end of the roller brush and the belt wheel is driven by a roller brush driving unit.

If the brush is a brush disposed on a sliding rail that is disposed on a side of the roller frame in which the load roller is installed in a longitudinal direction, and the sliding rail allows the brush to move to and fro along the load roller through the sliding rail.

It is another object of the present invention to provide a load roller device with a cleaning structure in a slot-in loading drive that includes a load roller, a roller frame used for supporting the load roller, and a brush installed on the roller frame and brush hairs thereof got in touch with the load roller so as to clean contaminants attached on the surface of the load roller. And, a first gear is installed at one end of the load roller for engaging with a driving unit.

If the brush is a roller brush, a second gear, which is driven by a roller brush driving unit, can be installed on one end of the roller brush or a belt wheel, which is driven by a roller brush driving unit, can be installed on one end of the roller brush.

If the brush is a brush disposed on a sliding rail that is disposed on a side of the roller frame in which the load roller is installed in a longitudinal direction, and the sliding rail allows the brush to move to and fro along the load roller through the sliding rail.

The term “touch” used in the present invention means that the touch between the brush hair and the surface of the load roller can be allowed under a condition that the rotation or driving of each element in the load roller device is not hindered.

### BRIEF DESCRIPTION OF THE DRAWINGS

The present invention can be more fully understood by reference to the following description and accompanying drawings, in which:

FIG. 1 is a prospective view, showing the loading and ejecting of a disc by a load roller of a load roller device in a conventional slot-in loading drive;

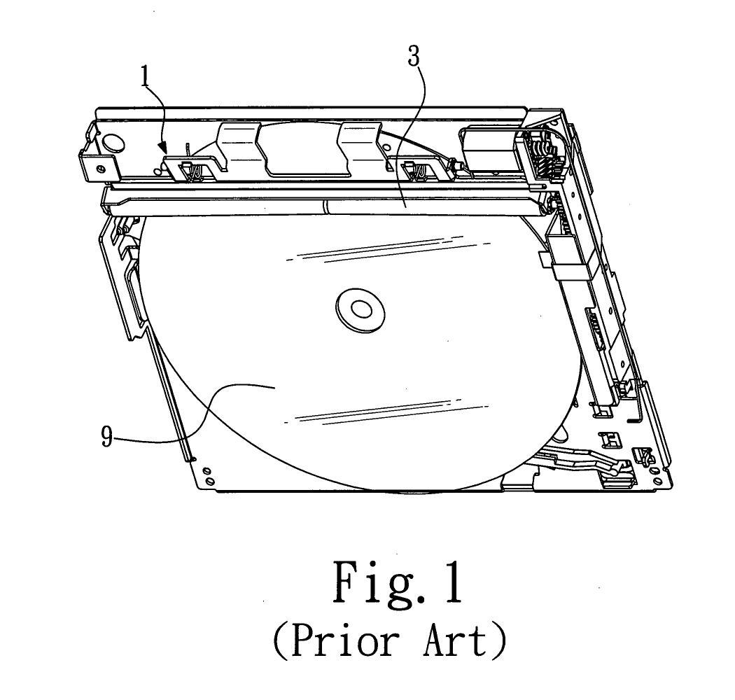

FIG. 2 is a prospective view, showing a load roller for loading and ejecting a disc in a conventional slot-in loading drive;

FIG. 3 is an explosive view, showing a load roller device with a cleaning structure of a preferred embodiment according to the present invention;

FIG. 4 is a prospective view, showing a load roller device with a cleaning structure of another preferred embodiment according to the present invention; and

FIG. 5 is a prospective view, showing a load roller device with a cleaning structure of still another preferred embodiment according to the present invention.

### DETAILED DESCRIPTION OF THE PREFERRED EMBODIMENTS

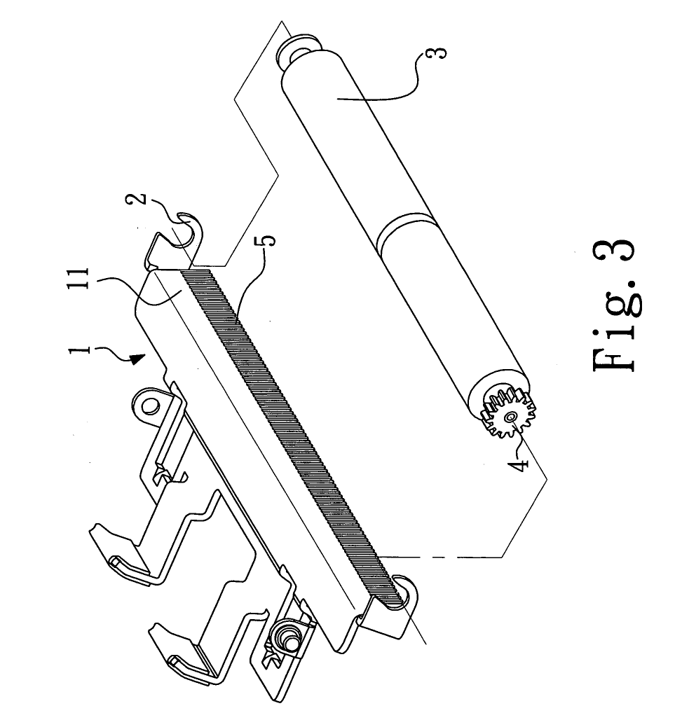

Please refer to FIG. 3. FIG. 3 is an explosive view showing a load roller device with a cleaning structure of a preferred embodiment according to the present invention. A load roller device with a cleaning structure comprises A roller frame 1, a roller supporting bracket 2, a load roller 3, a driving gear 4, and a brush 5. The roller supporting bracket 2 is installed on the roller frame 1 for supporting the load roller 3. The driving gear 4 is installed on the load roller 3 for engaging with a driving unit (not shown in the figure) such as a motor installed in a disc drive so that the driving gear 4 can be driven by the motor and further to make the load roller 3 rotate to convey a disc so that the loading and ejecting of the disc can be accomplished. The brush 5 that can be a row brush in this embodiment is fixed on a side 11 of the roller frame 1 in which the load roller 3 is installed in the longitudinal direction and at an angle allowing the brush 5 to be got in touch with the surface of the load roller 3. Therefore, when the load roller 3 is driven by the driving gear 4, the surface of the load roller 3 can simultaneously wiped by the brush 5 and the cleanness of the surface of the load roller 3 can be attained.

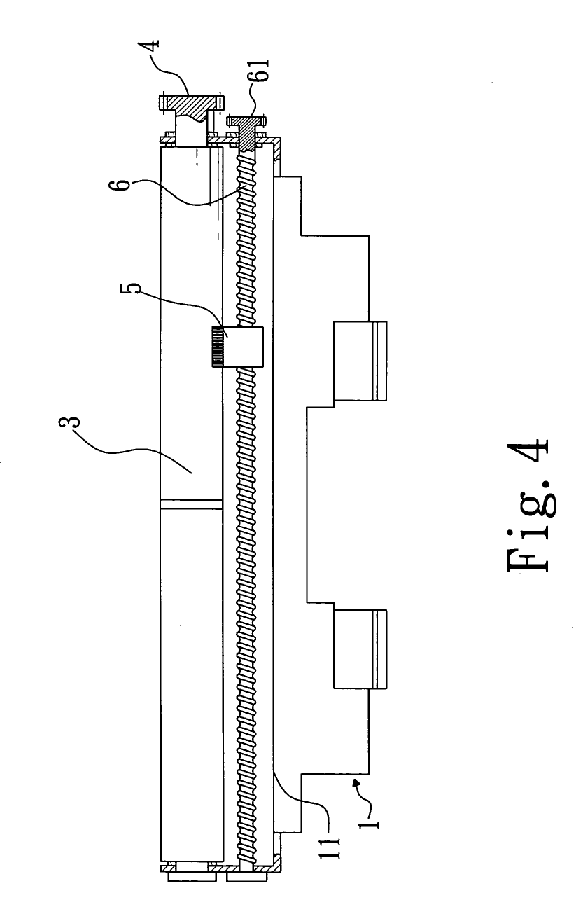

Please refer to FIG. 4. FIG. 4 is a prospective view showing a load roller device with a cleaning structure of another preferred embodiment according to the present invention. This preferred embodiment has a brush 5 with a length shorter than the one of the load roller 3, and a sliding rail 6. The sliding rail 6, which is a screw bolt in the figure, is disposed on a side 11 of the roller frame 1 where the load roller 3 is installed along the frame 1 in this preferred embodiment. The sliding rail 6 can be driven by the same driving unit as the one driving the load roller 3. Thus the sliding rail 6 is driven to rotate simultaneously when the load roller is driven by the driving unit to cause the brush 5 disposed on the sliding rail 6 to move to and fro along the load roller 3 in the longitudinal direction thereof and got in touch with the load roller 3 so that the cleanness of the whole surface of the load roller 3 can be attained.

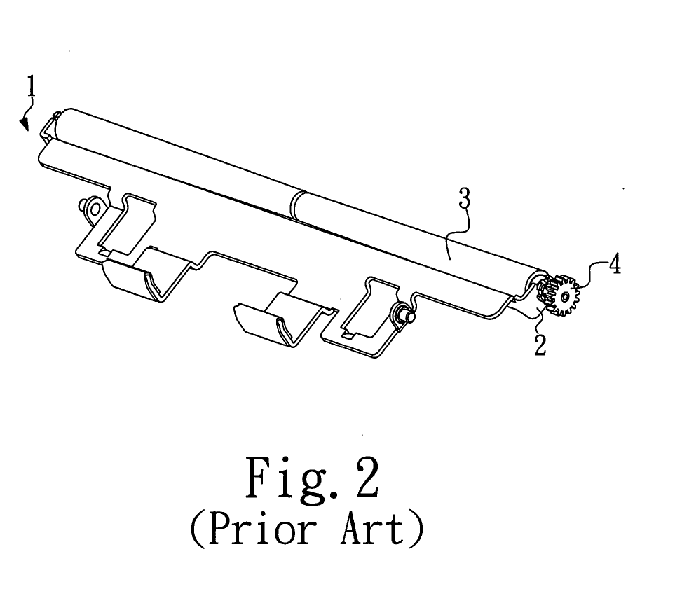

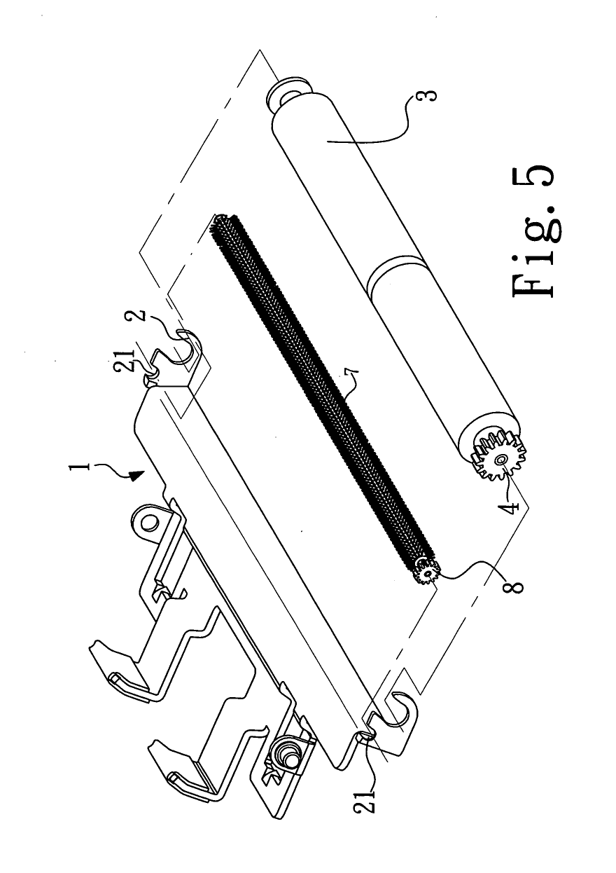

Next, please refer to FIG. 5. FIG. 5 is a prospective view showing a load roller device with a cleaning structure of still another embodiment according to the present invention. The load roller device of this preferred embodiment is basically similar to the one shown in FIG. 2, but the brush used in the embodiment is a roller brush 7. According to the preferred embodiment, a second supporting bracket 21 is further installed in the roller frame 1 to support the roller brush 7 in addition to the supporting bracket 2. The installment position thereof is to allow the brush hairs of the roller brush 7 to get in touch with the surface of the load roller 3. Since the hairs of the roller brush 7 is kept touching the load roller 3, a friction force can be utilized to drive the roller brush 7 to rotate when the load roller 3 is driven, and the cleanness of the load roller 3 can be attained at the same time.

Besides, a gear 8 can also be installed on at least one end of the roller brush 7 to allow the gear 8 be used to drive the roller brush 7 to rotate so as to attain the cleanness of the surface of the load roller 3. The rotation of the gear 8 can be driven by a roller driving unit, for instance, driven directly by a driving unit, driven directly by the driving unit used to drive the gear 4, or a gear is further used to engage with both the gear 4 and the gear 8 to allow the gear 4 and gear 8 to rotate relatively in an opposite direction so as to allow the roller brush 7 and the load roller 3 also to rotate relatively in an opposite direction. There are still many other ways to drive the roller brush 7 for those who skilled in the art after following the teaching of the present invention. For example, the gear 8 can be replaced by a belt wheel, and the roller brush 7 can be drive by a belt in the roller brush driving unit.

It is noted that the load roller device with a cleaning structure described above is the preferred embodiments of the present invention for the purpose of illustration only, and are not intended as a definition of the limits and scope of the invention disclosed. Any modifications and variations that may be apparent to a person skilled in the art are intended to be included within the scope of the present invention.

What is claimed is:

1. A load roller device with a cleaning structure, comprising:
a load roller;
a roller frame, used for supporting said load roller; and
a brush, installed on said roller frame and brush hairs thereof got in touch with said load roller so as to clean contaminants attached on the surface of said load roller.

2. The load roller device according to claim 1, wherein a gear is installed on at least one end of said load roller for engaging with a driving unit.

3. The load roller device according to claim 1, wherein said brush is a row brush.

4. The load roller device according to claim 3, wherein said brush is fixed on said roller frame.

5. The load roller device according to claim 1, wherein said brush is a roller brush.

6. The load roller device according to claim 5, wherein a gear is installed on at least one end of said roller brush and said gear is driven by a roller brush driving unit.

7. The load roller device according to claim 5, wherein a belt wheel is installed on at least one end of said roller brush and said belt wheel is driven by a roller brush driving unit.

8. The load roller device according to claim 1, wherein said brush is disposed on a sliding rail that is disposed on a side of said roller frame where said load roller is installed in a longitudinal direction, and said sliding rail is used for allowing said brush to move to and fro along said load roller through said sliding rail.

9. A load roller device with a cleaning structure in a slot-in loading drive, comprising:
a load roller;
a roller frame, used for supporting said load roller; and
a brush, installed on said roller frame and brush hairs thereof got in touch with said load roller so as to clean contaminants attached on the surface of said load roller;
wherein a first gear is installed at one end of said load roller for engaging with a driving unit.

10. The load roller device according to claim 9, wherein said brush is a row brush.

11. The load roller device according to claim 10, wherein said brush is directly connected on said roller frame.

12. The load roller device according to claim 9, wherein said brush is a roller brush.

13. The load roller device according claim 12, wherein a second gear is installed on one end of said roller brush and said second gear is driven by a roller brush driving unit.

14. The load roller device according to claim 12, wherein a belt wheel is installed on one end of said roller brush and said belt wheel is driven by a roller brush driving unit.

15. The load roller device according to claim 9, wherein brush is disposed on a sliding rail that is disposed on a side of said roller frame where said load roller is installed in a longitudinal direction, and said sliding rail is used for allowing said brush to move to and fro along said load roller through said sliding rail.
